(19) United States
(12) Patent Application Publication
(10) Pub. No.: US 2002/0007414 A1
(43) Pub. Date: Jan. 17, 2002

(54) Network system using dedicated downlink network and bidirectional network

(75) Inventors: Atsushi Inoue, Kanagawa (JP); Eiji Kamagata, Kanagawa (JP); Masahiro Takagi, Tokyo (JP); Masahiro Ishiyama, Tokyo (JP); Noriyasu Kato, Kanagawa (JP); Naohisa Shibuya, Saitama (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: KABUSHIKI KAISHA TOSHIBA, Kawasaki-shi (JP)

(21) Appl. No.: 09/842,862

(22) Filed: Apr. 27, 2001

(30) Foreign Application Priority Data
Apr. 28, 2000 (JP) 2000-131612

(51) Int. Cl. G06F 15/16

(52) U.S. Cl. 709/230; 709/246; 709/249

(57) ABSTRACT

A packet relay device for processing a request message of a prescribed protocol on behalf of a radio terminal is provided at a first sub-network which is capable of communications in the downlink direction with respect to the radio terminal only. Then, a request message encapsulated in an IP packer is transferred from the radio terminal to the packet relay device through the second sub-network which is capable of communications in both uplink direction and the downlink direction with respect to the radio terminal, and a response message corresponding to the request message is transferred from the packet relay device to the radio terminal, so that it becomes possible for the radio terminal to execute a prescribed protocol with respect to the first sub-network.

### BACKGROUND OF THE INVENTION

1. Field of the Invention

The present invention relates to a network system containing a radio terminal with a first communication interface which can only be used for reception and a second communication interface which can be used for transmission and reception, a first sub-network to which the radio terminal can be connected using the first communication interface through a radio base station of a downlink radio network, a second sub-network to which the radio terminal can be connected using the second communication interface through a bidirectional communication network, and a backbone network to which the first and second sub-networks are connected.

2. Description of the Related Art

In conjunction with the advances of the radio technology and the Internet technology, there are propositions for a system in which data communications can be carried out by a radio terminal that is carried around by a user while moving. In particular, a system for downloading necessary data from a server on the Internet through a radio network has been attracting much attentions. The radio network to be used in such cases can be provided by the existing public communication network such as that of PDC (Personal Digital Cellular) or PHS (Personal Handy-phone System), or by a radio LAN or a new radio network.

As a technique for guaranteeing the mobile transparency of communications with respect to a terminal that moves across networks on the IP (Internet Protocol) network in general, there is a proposition called Mobile IP (RFC 2002, “IP Mobility Support”) in the IETF (Internet Engineering Task Force).

FIG. 1 shows a typical network configuration in the Mobile IP.

A mobile terminal (MN: Mobile Node) 2011 is a terminal that moves over networks, and a correspondent terminal (CN: Correspondent Node) 2010 is a terminal that carries out communications with the mobile terminal 2011. A home network 2021 is a network to which the mobile terminal 2011 belongs, on which a home agent (HA) 2012 for supporting the mobility of the mobile terminal 2011 exists. A foreign network 2022 is a visited site network of the mobile terminal 2011 that is other than the home network 2021, on which a foreign agent (FA) 2013 for supporting communications of the mobile terminal 2011 at the foreign network 2022 exists. There is also a backbone network (IP network) 2020 as shown in FIG. 1.

The home agent 2012 manages information regarding a current location of the mobile terminal 2011, and receives an IP packet destined to a home address of the mobile terminal 2011 that is transmitted by the correspondent terminal 2010, on behalf of the mobile terminal 2011, and transfers a packet encapsulating the received IP packet which is destined to a care-of address on the foreign network 2022 to which the mobile terminal 2011 currently belongs. The care-of address of the mobile terminal 2011 that carries out communications through the foreign agent 2013 on the foreign network 2022 is given by an address of the foreign agent 2013. Here, the encapsulation is a technique for transmitting an IP packet by containing it in another IP packet. Namely, the IP packet destined to the home address of the mobile terminal 2011 is transmitted by being encapsulated in an IP packet destined to the care-of address, and this encapsulating IP packet is transmitted to the foreign agent 2013 on the foreign network 2022 to which the mobile terminal 2011 currently belongs.

When this encapsulating IP packet is received, the foreign agent 2013 decapsulates it and transfers the decapsulated IP packet to the mobile terminal 2011. In this case, the destination address of the IP packet transferred to the mobile terminal 2011 is the home address of the mobile terminal 2011.

By carrying out communications with the correspondent terminal 2010 at the foreign network 2022 in this way, the mobile terminal 2011 can carry out communications as if it is always located in the home network 2021 by receiving the support of the home agent 2012 and the foreign agent 2013.

Also, when the mobile terminal 2011 moves from the home network 2021 to the foreign network 2022, the mobile terminal 2011 is required to carry out a registration processing with respect to the home agent 2012 and the foreign agent 2013 in order to obtain the support of the home agent 2012 and the foreign agent 2013. Each one of the home agent 2012 and the foreign agent 2013 periodically broadcasts or multicasts an agent advertisement message for the purpose of notifying a current location and indicating an intention to provide services to the mobile terminal 2011.

The mobile terminal 2011 that has moved from the home network 2021 to the foreign network 2022 transmits a registration request message to the foreign agent 2013 by utilizing information contained in the received agent advertisement message. Upon receiving the registration request message, the foreign agent 2013 ascertains the IP address of the home agent 2012 from information contained in the registration request message, and transfers the registration request message to the home agent 2012 of the home network 2021 of the mobile terminal 2011. Upon receiving the registration request message, the home agent 2012 carries out the registration processing for the mobile terminal 2011, and transmits a registration response to the foreign agent 2013. Upon receiving the registration response, the foreign agent 2013 transfers it to the mobile terminal 2011.

Conversely, the mobile terminal 2011 that has moved from the foreign network 2022 to the home network 2021 transmits a registration release request message directly to the home agent 2012 by utilizing information contained in the received agent advertisement message. Upon receiving the registration release request message, the home agent 2012 releases the registration.

Now, in general, it is difficult to extend a radio network for carrying out high speed communications to a wide area in short period of time, so that such a high speed radio service is usually provided at sporadic spot service areas. In such a case, in order to eliminate a disadvantage regarding the service continuity, a radio terminal having a plurality of radio interfaces may be employed such that one radio interface is used for an existing public communication radio network that is low speed but covers a wide area while another radio interface is used for a new high speed radio network.

Moreover, in the case of implementing the high speed radio communication function on the terminal side in general, the inclusion of the transmission function can cause problems regarding the battery durability and the radio device cost. Also, in the case of the downloading system in general, only a limited number of packets for ACK or the like will be transmitted in the uplink direction (terminal → network direction; uploading), in contrast to the downlink direction (network → terminal direction; downloading) in which a large amount of data are transferred.

In view of the above noted points, it is possible to consider the use of a radio terminal which has a first radio interface dedicated for reception and a second radio interface capable of both transmission and reception, where the first radio interface is used exclusively for communications in the downlink direction on the high speed radio network and the second radio interface is used for the existing public network. In this case, the first radio interface is dedicated for reception, so that it would become impossible to use the existing Internet protocol that was designed by assuming the availability of bidirectional communications.

For example, consider the case where a portable terminal acquires an address dynamically on the high speed radio network side. There is a protocol for dynamically allocating an IP address in the IP network called DHCP (Dynamic Host Configuration Protocol). This is a protocol in which a broadcast request message is transmitted to a network in which the address allocation is requested, and a DHCP server that received this request message will allocate an address from a group of addressed pooled in advance.

Even if an attempt to apply this protocol to the high speed radio network side of the radio terminal described above is made, it is impossible to transmit a DHCP request directly to the high speed radio network side so that DHCP cannot be applied directly.

Thus when a radio mobile terminal having a radio interface dedicated for reception and a radio interface capable of both transmission and reception is used, there can be cases where it becomes impossible to use the protocol usually used on the IP network due to the asymmetry of the networks.

### BRIEF SUMMARY OF THE INVENTION

It is therefore an object of the present invention to provide a network system in which a radio terminal having a radio interface dedicated for reception can execute a prescribed protocol with respect to a network to which the radio terminal is connected by using that radio interface dedicated for reception.

According to one aspect of the present invention there is provided a network system, comprising: a radio terminal having a first communication interface usable for reception only and a second communication interface usable for transmission and reception; a first sub-network to which the radio terminal can be connected through a radio base station of a downlink radio network by using the first communication interface; a second sub-network to which the radio terminal can be connected through a bidirectional communication network by using the second communication interface, the second sub-network being connected with the first sub-network through a backbone network; and a packet relay device configured to receive a request message requesting a protocol processing with respect to the first sub-network from the radio terminal through the second sub-network, and carry out the protocol processing on the first sub-network according to the request message on behalf of the radio terminal, such that a response message corresponding to the request message obtaining by the protocol processing is returned from the first sub-network to the radio terminal through the downlink radio network or the bidirectional communication network.

According to another aspect of the present invention there is provided a packet relay device for use in a network system containing a radio terminal having a first communication interface usable for reception only and a second communication interface usable for transmission and reception, a first sub-network to which the radio terminal can be connected through a radio base station of a downlink radio network by using the first communication interface, and a second sub-network to which the radio terminal can be connected through a bidirectional communication network by using the second communication interface, the second sub-network being connected with the first sub-network through a backbone network, the packet relay device comprising: a communication interface configured to receive an encapsulated IP packet containing a request message requesting a protocol processing with respect to the first sub-network, which is transferred from the radio terminal located in a radio area of the radio base station through the second sub-network; a processing unit configured to decapsulate the encapsulated IP packet received by the communication interface so as to take out the request message, and carry out the protocol processing on the first sub-network according to the request message on behalf of the radio terminal.

According to another aspect of the present invention there is provided a radio terminal for use in a network system containing a first sub-network to which the radio terminal can be connected through a radio base station of a downlink radio network, a second sub-network to which the radio terminal can be connected through a bidirectional communication network, the second sub-network being connected with the first sub-network through a backbone network, and a packet relay device for carrying out a protocol processing on the first sub-network on behalf of the radio terminal, the radio terminal comprising: a first communication interface usable for reception only, by which the radio terminal can be connected to the first sub-network, which is configured to receive a notification message indicating an existence or an address of the packet relay device on the first sub-network through the downlink radio network when the radio terminal enters a radio area of the radio base station; a second communication interface usable for transmission and reception, by which the radio terminal can be connected to the second sub-network, which is configured to transmit a request message requesting a protocol processing with respect to the first sub-network after receiving the notification message at the first communication interface, by encapsulating the request message into an IP (Internet Protocol) packet destined to the address of the packet relay device obtained according to the notification message and transmitting the IP packet through the second sub-network; and a processing unit configured to process a response message corresponding to the request message obtained by the protocol processing.

According to another aspect of the present invention there is provided a packet processing method in a network system containing a radio terminal having a first communication interface usable for reception only and a second communication interface usable for transmission and reception, a first sub-network to which the radio terminal can be connected through a radio base station of a downlink radio network by using the first communication interface, a second sub-network to which the radio terminal can be connected through a bidirectional communication network by using the second communication interface, the second sub-network being connected with the first sub-network through a backbone network, and a packet relay device for carrying out a protocol processing on the first sub-network on behalf of the radio terminal, the method comprising: receiving a request message requesting a protocol processing with resoect to the first sub-network from the radio terminal through the second sub-network at the packet relay device; carrying out the protocol processing on the first sub-network according to the request message on behalf of the radio terminal at the packet relay device; and returning a response message corresponding to the request message obtained by the protocol processing from the first sub-network to the radio terminal through the downlink radio network or the bidirectional communication network.

According to another aspect of the present invention there is provided a packet processing method at a packet relay device in a network system containing a radio terminal having a first communication interface usable for reception only and a second communication interface usable for transmission and reception, a first sub-network to which the radio terminal can be connected through a radio base station of a downlink radio network by using the first communication interface, a second sub-network to which the radio terminal can be connected through a bidirectional communication network by using the second communication interface, and the second sub-network being connected with the first sub-network through a backbone network, the method comprising: receiving an encapsulated IP packet containing a request message requesting a protocol processing with respect to the first sub-network, which is transferred from the radio terminal located in a radio area of the radio base station through the second sub-network; and decapsulating the encapsulated IP packet received by the receiving step so as to take out the request message, and carrying out the protocol processing on the first sub-network according to the request message on behalf of the radio terminal.

According to another aspect of the present invention there is provided a packet processing method at a radio terminal in a network system containing a first sub-network to which the radio terminal can be connected through a radio base station of a downlink radio network, a second sub-network to which the radio terminal can be connected through a bidirectional communication network, the second sub-network being connected with the first sub-network through a backbone network, and a packet relay device for carrying out a protocol processing on the first sub-network on behalf of the radio terminal, the method comprising: receiving a notification message indicating an existence or an address of the packet relay device on the first sub-network through the downlink radio network when the radio terminal enters a radio area of the radio base station, using a first communication interface usable for reception only, by which the radio terminal can be connected to the first sub-network; transmitting a request message requesting a protocol processing with respect to the first sub-network after receiving the notification message at the first communication interface, by encapsulating the request message into an IP (Internet Protocol) packet destined to the address of the packet relay device obtained according to the notification message and transmitting the IP packet through the second sub-network, using a second communication interface usable for transmission and reception, by which the radio terminal can be connected to the second sub-network; and processing a response message corresponding to the request message obtained by the protocol processing.

According to another aspect of the present invention there is provided a computer usable medium having computer readable program codes embodied therein for causing a computer to function as a packet relay device in a network system containing a radio terminal having a first communication interface usable for reception only and a second communication interface usable for transmission and reception, a first sub-network to which the radio terminal can be connected through a radio base station of a downlink radio network by using the first communication interface, and a second sub-network to which the radio terminal can be connected through a bidirectional communication network by using the second communication interface, the second sub-network being connected with the first sub-network through a backbone network, the computer readable program codes include: a first computer readable program code for causing said computer to receive an encapsulated IP packet containing a request message requesting a protocol processing with respect to the first sub-network, which is transferred from the radio terminal located in a radio area of the radio base station through the second sub-network; and a second computer readable program code for causing said computer to decapsulate the encapsulated IP packet received by the first computer readable program code so as to take out the request message, and carry out the protocol processing on the first sub-network according to the request message on behalf of the radio terminal.

According to another aspect of the present invention there is provided a computer usable medium having computer readable program codes embodied therein for causing a computer to function as a radio terminal in a network system containing a first sub-network to which the radio terminal can be connected through a radio base station of a downlink radio network, a second sub-network to which the radio terminal can be connected through a bidirectional communication network, the second sub-network being connected with the first sub-network through a backbone network, and a packet relay device for carrying out a protocol processing on the first sub-network on behalf of the radio terminal, the computer readable program codes include: a first computer readable program code for causing said computer to receive a notification message indicating an existence or an address of the packet relay device on the first sub-network through the downlink radio network when the radio terminal enters a radio area of the radio base station, using a first communication interface usable for reception only, by Which the radio terminal can be connected to the first sub-network; a second computer readable program code for causing said computer to transmit a request message requesting a protocol processing with respect to the first sub-network after receiving the notification message at the first communication interface, by encapsulating the request message into an IP (Internet Protocol) packet destined to the address of the packet relay device obtained according to the notification message and transmitting the IP packet through the second sub-network, using a second communication interface usable for transmission and reception, by which the radio terminal can be connected to the second sub-network; and a third computer readable program code for causing said computer to process a response message corresponding to the request message obtained by the protocol processing.

Other features and advantages of the present invention will become apparent from the following description taken in conjunction with the accompanying drawings.

### BRIEF DESCRIPTION OF THE DRAWINGS

FIG. 1 is a schematic diagram showing a network configuration according to the conventional Mobile IP scheme.

FIG. 2 is a block diagram showing an exemplary configuration of a network system according to one embodiment of the present invention.

FIG. 3 is a block diagram showing an exemplary configuration of a radio terminal in the network system of FIG. 2.

FIG. 4 is a block diagram showing an exemplary configuration of a packet relay device in the network system of FIG. 2.

FIG. 5 is a sequence chart for one exemplary processing sequence that can be carried out in the network system of FIG. 2.

FIG. 6 is a sequence chart for another exemplary processing sequence that can be carried out in the network system of FIG. 2.

FIG. 7 is a diagram showing an exemplary format of an agent advertisement message with an extension that can be used in the network system of FIG. 2.

FIG. 8 is a diagram showing an exemplary encapsulated IP packet for transferring a request message that can be used in the network system of FIG. 2.

FIG. 9 is a diagram showing a packet processing to be applied to a request message at a packet relay device in the network system of FIG. 2.

FIG. 10 is a diagram showing a packet processing to be applied to a response message at a packet relay device in the network system of FIG. 2.

FIG. 11 is a sequence chart for still another exemplary processing sequence that can be carried out in the network system of FIG. 2.

### DETAILED DESCRIPTION OF THE INVENTION

First, the major features of the present invention will be summarized briefly.

Conventionally, in a system combining a downlink network dedicated for reception and a bidirectional network, the protocol usually used in the IP network cannot used directly in the downlink network side because this network is unidirectional.

In the present invention, a packet relay device is provided on the downlink network, and a protocol request to the downlink network side is transmitted to the packet relay device in a form of an encapsulated IP packet from the radio terminal through the bidirectional network side. Upon receiving this packet, the packet relay device carries out a prescribed protocol operation on the downlink network side on behalf of the radio terminal, and transfers an acquired response to the radio terminal that issued the protocol request, similarly via the bidirectional network.

By this control, even on the downlink network side where only a unidirectional link is available, it becomes possible to use the protocol usually used in the IP network by transferring messages through the bidirectional network side, so that the conventionally used Internet devices can be easily applied to such a system having asymmetrical transmission paths, and therefore it becomes possible to construct a system easily at low cost.

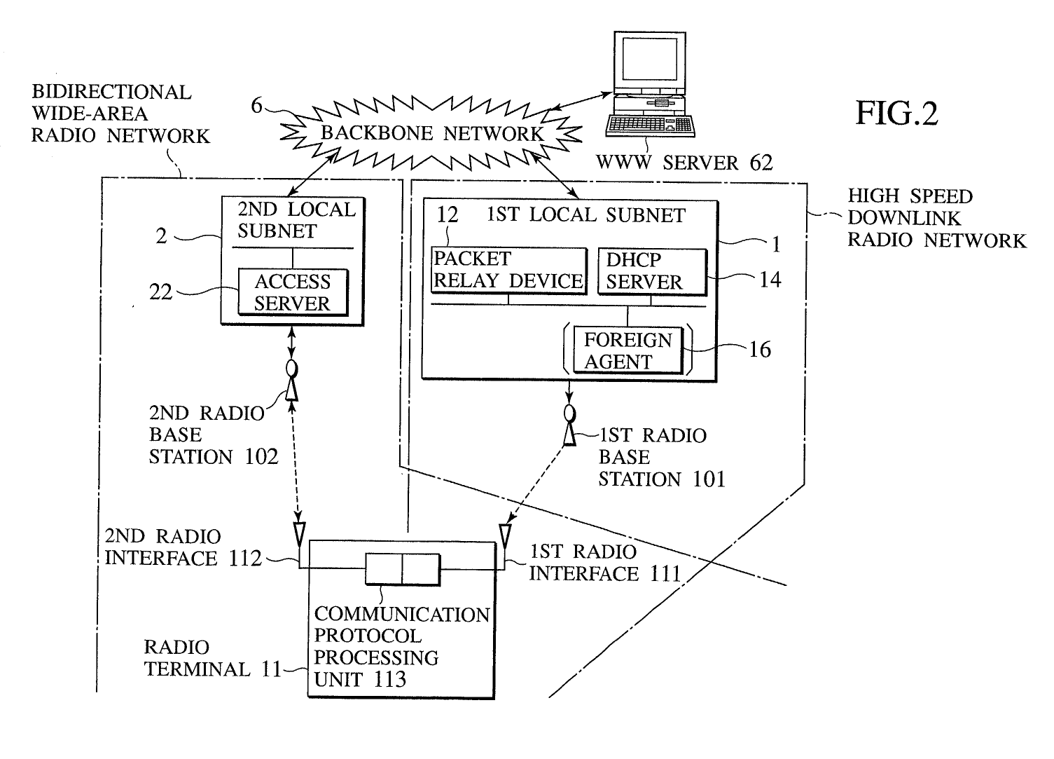

Referring now to FIG. 2 to FIG. 11, one embodiment of the network system according to the present invention will be described in detail.

FIG. 2 shows an exemplary configuration of a network system including a radio terminal device and a packet relay device according to one embodiment of the present invention.

As shown in FIG. 2, this network system comprises a first local local subnet 1 to which a radio terminal 11 can be connected through a first radio base station 101 in a high speed downlink radio network, a second local subnet 2 to which the radio terminal 11 can be connected through a second radio base station 102 in a bidirectional wide-area radio network, and a backbone network (Internet, for example) 6 to which the first and second local subnets 1 and 2 are connected. The radio terminal is capable of being connected to the backbone network 6 via the first or second local subnet 1 or 2 (through the first or second radio base station 101 or 102), and carrying out communications with a terminal or server (WWW server 62, for example) that is connected to the backbone network 6 either directly or through another subnet. Note that FIG. 2 shows only one radio terminal 11, but it should be apparent that the system can have a plurality of radio terminals.

The radio terminal 11 has a first radio interface 111 for carrying out communications with the first radio base station 101, a second radio interface 112 for carrying out communications with the second radio base station 102, and a communication protocol processing unit 113 which has the basic communication protocol processing functions such as the datalink layer processing function and the TCP/IP protocol processing function (including the IP layer processing function, the TCP layer processing function, PPP (Point to Point Protocol; RFC 1661) processing function, etc.) as well as other protocol processing functions to be provided according to the need (such as a Mobile IP protocol processing function which is to be provided in the case where the radio terminal 11 is capable of operating as a mobile node (MN) according to the Mobile IP, for example).

The first radio interface 111 of the radio terminal 11 may have the reception function alone (it is assumed to have the reception function alone in this embodiment). On the other hand, the second radio interface 112 is assumed to have the transmission function at least (it is assumed to have the transmission and reception function in this embodiment). In this embodiment, only communications in the downlink direction from the first radio base station 101 to the radio terminal 11 are supported as communications between the first radio base station 101 and the radio terminal 11 by using the first radio interface 111. Communications in the uplink direction that are necessary in relation to the communications in the downlink direction will be carried out via the second radio base station 102 by using the second radio interface 112.

Also, in this embodiment, the radio terminal 11 is assumed to have functions as a computer.

A plurality of first radio base stations 101 that constitute the high speed downlink radio network and the first radio interface 111 of each mobile terminal 11 can be realized by the radio LAN as specified in the IEEE 802.11, for example, or by the satellite communications.

A plurality of second radio base stations 102 that constitute the bidirectional wide-area radio network and the second radio interface 112 of each mobile terminal 11 can be realized by utilizing the PHS or portable telephone for data communications. The moving control in the case where the accommodating second radio base station 102 is changed as the mobile terminal 11 moves is carried out by functions in the bidirectional wide-area radio network.

Here, it is assumed that the radio area of the high speed downlink radio network formed by the first radio base stations 101 is contained within the radio area of the bidirectional wide-area radio network formed by the second radio base stations 102 (that is, it is assumed that the radio terminal 11 is in a state capable of carrying out communications with the second radio base station 102 whenever it is in a state capable of carrying out communications with the first radio base station 101).

Also, there can be cases where there is a unique local subnet that can be connected through the first radio base stations of the high speed downlink radio network (the cases where the radio terminal becomes an IP node of the identical local subnet regardless of which first radio base station or which group of first radio base stations it is connected to), and cases where there are a plurality of such local subnets (the cases where the radio terminal can be an IP node of different local subnets depending on which first radio base station or which group of first radio base stations it is connected to). In either case, there may or may not be areas in which only communications with the second radio base station 102 is possible (that is, areas at which communications with the first radio base station 101 is impossible).

Also, in this embodiment, a packet relay device 12 is provided on the first local subnet 1. This packet relay device 12 carries out the processing on behalf of the radio terminal 11 in the case where the radio terminal 11 needs to carry out or request a procedure according to a prescribed protocol with respect to the first local subnet 1, as will be described in detail below.

In addition, various types of servers or routers are provided on the first local subnet 1 according to the need (FIG. 2 shows an exemplary case where a DHCP server 14 (for the purpose of using the DHCP) and a foreign agent 16 of the Mobile IP (for the purpose of using the Mobile IP) are provided). Similarly, various types of servers or routers are provided on the second local subnet 2 (FIG. 2 shows an exemplary case where an access server 22 (for the purpose of using the PPP) is provided). Note that, in the case where the foreign agent 16 of the Mobile IP is to be provided on the first local subnet 1, the home agent of the Mobile IP can be provided on the second local subnet, for example.

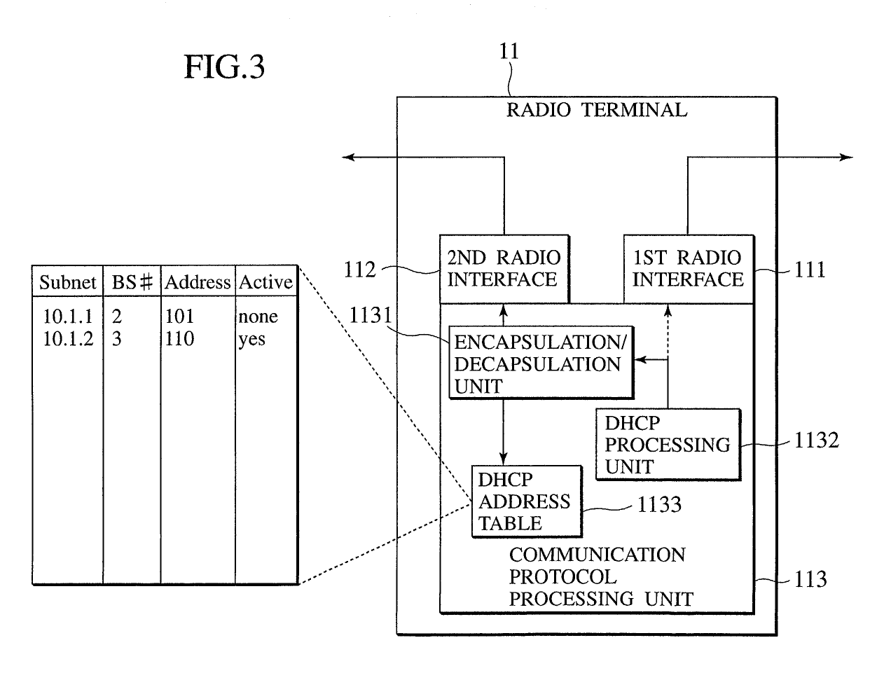

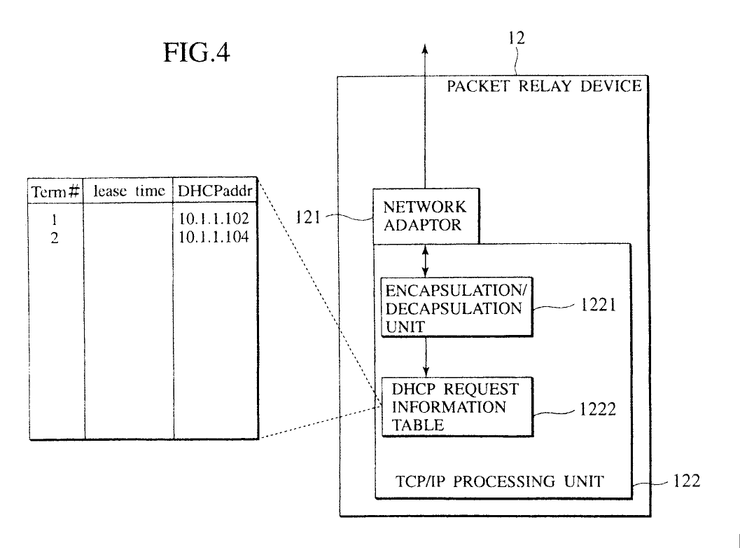

In further detail, in the case of using the DHCP, the radio terminal 11 has a configuration shown in FIG. 3, where the communication protocol (TCP/IP) processing unit 113 includes an encapsulation/decapsulation unit 1131, a DHCP processing unit 1132, and a DHCP address table 1133. Also, in this case, the packet relay device 12 has a configuration shown in FIG. 4, which comprises a network adaptor 121 and a TCP/IP processing unit 122 including an encapsulation/decapsulation unit 1221 and a DHCP request information table 1222.

Now, the processing sequence in the network system of this embodiment will be described.

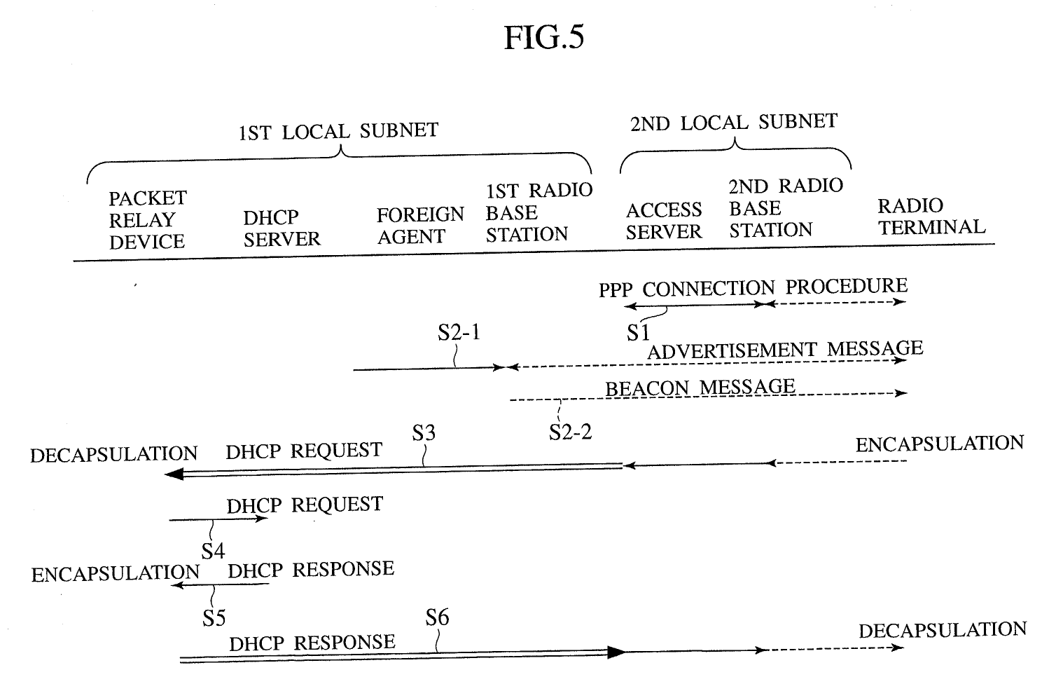

FIG. 5 shows an exemplary overall processing sequence according to this embodiment.

First, the radio terminal 11 establishes an IP connection based on PPP with respect to the access server 22 provided in the second local subnet 2, through the second radio base station 102 in the bidirectional wide-area radio network, by using the second radio interface 112 (regardless of whether it is located within a radio area of the first radio base station 101 that is mapped to the first local subnet 1) (step S1 of FIG. 5).

Note that, in order to establish this IP connection, the negotiation of various parameters regarding PPP and the authentication of the radio terminal 11 will be carried out between the communication protocol processing unit 113 of the radio terminal 11 and the access server 22, but details of a procedure for doing them will be omitted here. The PPP connection negotiation may include exchange of a plurality of messages.

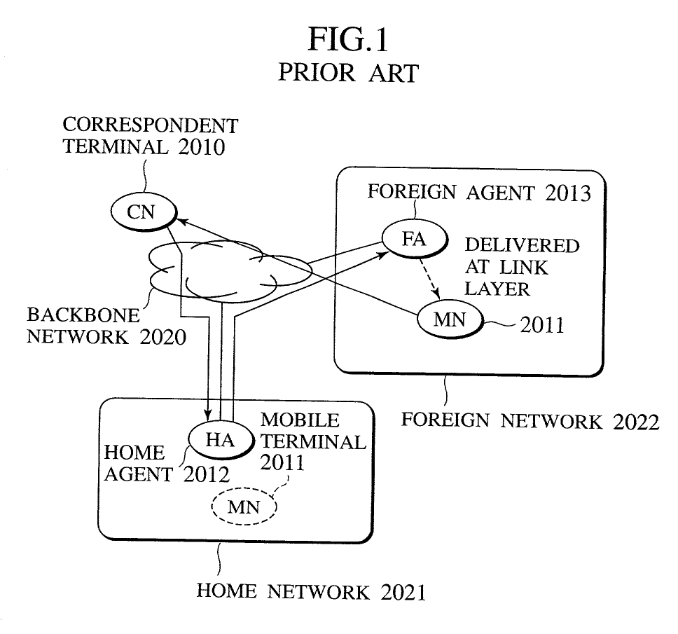

When the PPP connection negotiation is completed, the radio terminal 11 is put in a state of being connected to the backbone network 6 IP-wise in which it is possible to carry out communications with arbitrary device (the WWW server 62 or the packet relay device 12 (but only after the address is acquired) of FIG. 1, for example) that is connected to the backbone network 6 IP-wise. At this point, an IP address in the second local subnet 2 connected through the second radio base station 102 is allocated to the radio terminal 11.

At this stage, communications between the radio terminal 11 and arbitrary device that is connected to the backbone network 6 IP-wise including both communications in the uplink direction (a direction for transmitting from the radio terminal 11) and communications in the downlink direction (a direction for receiving at the radio terminal 11) will be carried out through the second local subnet 2 (the second radio base station 102).

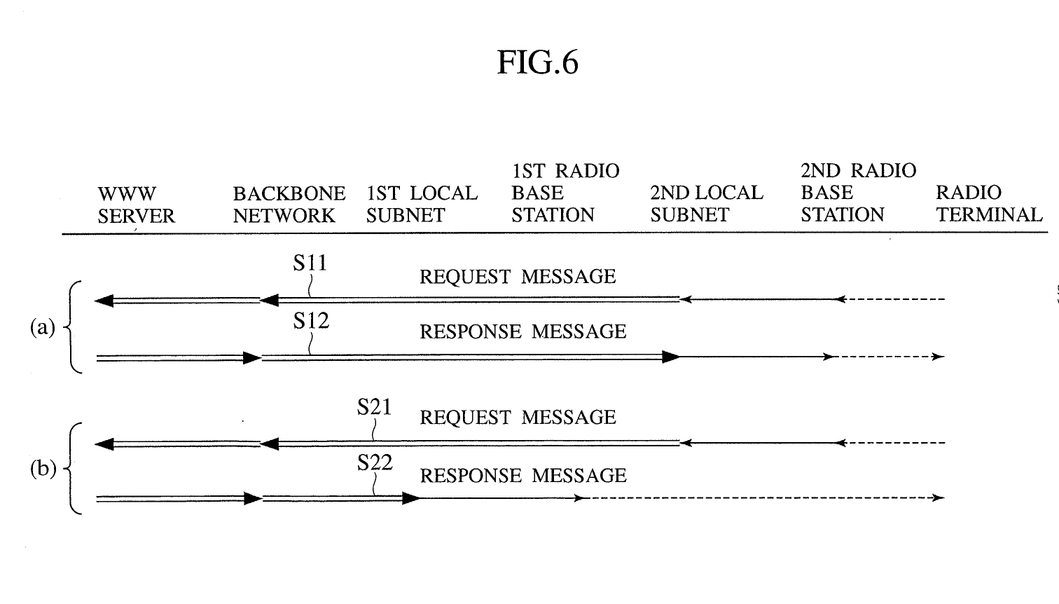

A part (a) of FIG. 6 shows an exemplary case of communications with the WWW server 62.

The radio terminal 11 transmits a request message with respect to the WWW server 62 from the second radio interface 112, and this request message is received by the WWW server 62 through the second radio base station 102, the second local subnet 2 and the backbone network 6 (step S11 of FIG. 6). The WWW server 62 processes this request message and transmits a response message for this request message. This response message is received by the second radio interface 112 of the radio terminal 11 through the backbone network 6, the second local subnet 2 and the second radio base station 102 (step S12 of FIG. 6). The radio terminal 11 processes the received response message.

Next, when the radio terminal 11 moves into the radio area of the first radio base station 101, communications in the downlink direction are to be carried out through the first radio base station 101. In this case, according to the TCP/IP, there are many communication protocols for carrying out data retrieval or setting with respect to the first local subnet 1 to which the first radio base station 101 is connected.

In this case, the communication protocol processing unit 113 of the radio terminal 11 outputs packets that would be outputted to the first radio interface 111 side in the ordinary TCP/IP communications, to an uplink of the second radio interface 112 side (because the first radio interface 111 is dedicated for the downlink direction). To this end, it is assumed that it is possible to switch an output interface of packets in a socket mechanism for communications.

For example, consider the case of using the DHCP (Dynamic Host Configuration Protocol) for acquiring the address dynamically at the first local subnet 1 to which the first radio base station 101 is connected. However, the radio link on the first radio base station 101 side is capable of carrying out communications only in the downlink direction, so that it cannot carry out the ordinary protocol operation to transmit a DHCP request message using the subnet broadcast and receiving a response to it from the DHCP server 14.

For this reason, in this embodiment, the transfer of the broadcast message that would be done from the first radio base station 101 side under the ordinary circumstance will be done from the second radio base station 102 side through the packet relay device 12. namely, the packet relay device 12 operates on behalf of the radio terminal 11 as if the radio terminal 11 is carrying out a prescribed protocol by being connected to the first local subnet 1.

Here, there is a need to enable the radio terminal 11 to acquire an address of the packet relay device 12 on the first local subnet 1 and attributes of that packet relay device 12 (a protocol (group) for supporting that packet relay device 12, for example). This can be realized by various methods, including the following two examples.

A method of notification by encoding the address and the attributes of the packet relay device 12 within a prescribed message that is transmitted (by broadcast or multicast) regularly from the first radio base station 101 to the radio terminal 11 on the first local subnet 1 (step S22-1 of FIG. 5).

A method of acquiring the address and the attributes of the packet relay device 12 by inquiring to a resource database in the system, using a base station identifier (BS-ID) in a beacon message (base station management information) issued by the first radio base station 101 as a key (step S2-2 of FIG. 5).

Note that these two methods can be used in combination.

In the following, each one of these methods will be described separately.

In the case of the system as shown in FIG. 1 in which the Mobile IP based mobile management is carried out, the detection of the moving between subnets and the routing switching are executed according to the specification of the Mobile IP. In this case, when the radio terminal 11 enters the radio area mapped to some subnet (the first local subnet 1), the radio terminal 11 as a mobile node of the Mobile IP carries out the detection of a subnet (the first local subnet 1) to which the radio terminal 11 is belonging, according to the agent advertisement message regularly transmitted from the foreign agent 16 provided in that subnet (the first local subnet 1).

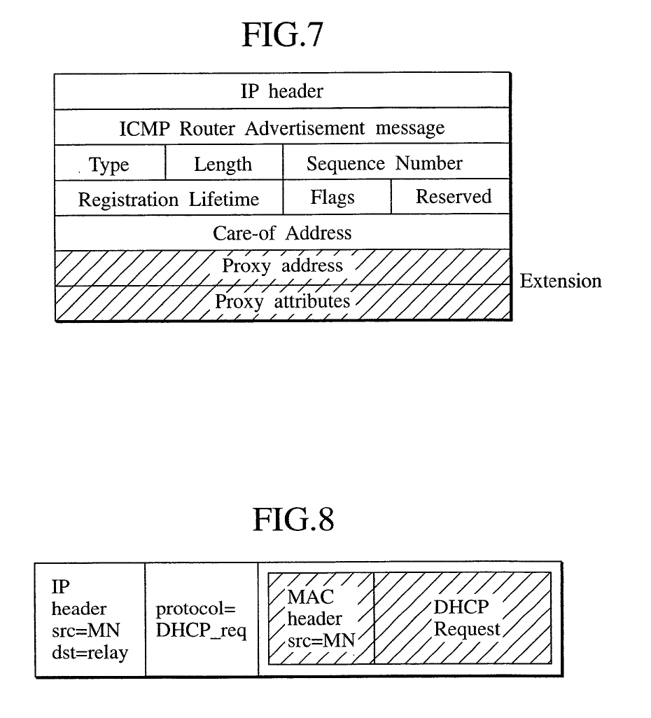

Thus, this agent advertisement message can be extended to include the address of the packet relay device 12 for relaying packets in that subnet (first local subnet 1) and attribute information indicating protocol supported by that packet relay device 12. An exemplary form of the agent advertisement message incorporating this extension is shown in FIG. 7. Of course, any other message that is regularly transmitted to the radio terminal 11 can also be utilized. Also, the packet relay device 12 itself may transmit an advertisement message containing the address and the attribute information of the packet relay device 12.

On the other hand, in general, the radio base station (the first radio base station 101) regularly transmits the beacon message containing the base station identifier of that radio base station, so that when the radio terminal 11 is connected to the first radio base station 101 which has that base station identifier, the radio terminal 11 can acquire the address and the attribute information of the packet relay device 12 provided in the first local subnet 1 to which the first radio base station 101 belongs, by accessing a database in the system (through the second radio base station 102 by using the second radio interface 112) using the base station identifier as a key information.

For example, the LDAP (Lightweight Directory Access Protocol) can be used for this purpose in such a manner that the data retrieval using the base station identifier of the first radio base station 101 as the key information can be carried out by accessing an LDAP server connected to the backbone network 6 similarly as in the procedure shown in a part (a) of FIG. 6. Note that the beacon message may contain a flag indicating whether the packet relay device 12 exists ore not.

Note that, in the methods described above, it is also possible to notify the address information for various servers other than the packet relay device 12 or include a group of flags for indicating whether various servers other than the packet relay device 12 exist or not.

By the methods described above, the radio terminal 11 can ascertain the address and the attributes of the packet relay device 12 on the first local subnet 1 to which the currently communicating first radio base station 101 is connected, and becomes capable of transferring the broadcast packet by encapsulating it in a packet destined to that packet relay device 12.

Now, the communication protocol processing unit 113 of the radio terminal 11 recognizes that the radio terminal 11 has entered the radio area of the first radio base station 101 that is mapped to the first local subnet 1 by receiving the agent advertisement message or beacon message transmitted from the first radio base station 101 through the first radio interface 111, for example, and acquires the address and the attributes of the packet relay device 12 on the first local subnet 1 to be operated on behalf of the radio terminal 11 according to the received agent advertisement message or beacon message.

Then, the radio terminal 11 encapsulates the DHCP request broadcast packet (having the radio terminal 11 as a source in the MAC header) with respect to the first local subnet 1 into an IP packet (having the radio terminal 11 as a source, the packet relay device 12 as a destination, and the DHCP request as a protocol field in the IP header) as shown in FIG. 8, and transmits this packet destined to the packet relay device 12 by using the second radio interface 112 (step S3 of FIG. 5).

This encapsulated DHCP request broadcast packet is received by the packet relay device 12 on the first local subnet 1 through the second radio base station 102, the second local subnet 2 and the backbone network 6 (step S3 of FIG. 5).

Upon receiving this encapsulated packet, the packet relay device 12 judges a protocol to be executed on behalf of the radio terminal 11 by referring to the protocol field of the packet. In this example, it is judged as the DHCP so that the packet relay device 12 recognizes that the IP address is to be acquired by the DHCP on behalf of the radio terminal 11, and transmits the DHCP request broadcast packet that has transferred as a payload of the encapsulated packet, to the first local subnet 1 (step S4 of FIG. 5).

Here, in the case of the DHCP, a link broadcast with the MAC address of the first radio interface 111 side of the radio terminal 11 attached thereto is to be transferred, by either one of the following two methods.

(i) A method in which the packet relay device 12 transfers it by replacing the MAC address of the radio terminal 11 in the DHCP request message to the MAC address of the packet relay device 12, receives the DHCP response message for this request, and returns this response to the radio terminal 11.

(ii) A method in which the packet relay device 12 transfers the DHCP request message without making any change so that the DHCP response message will be sent directly to the radio terminal 11 through the first radio base station 101.

Among these two methods, the method (ii) may be adopted in the case where the protocol is relatively simple and there is no need for the protocol state maintaining or the setting change on the client side according to the protocol end state, but it is preferable to adopt the method (i) because the subnet based server-client protocol makes complicated state transitions including those of the error processing in general.

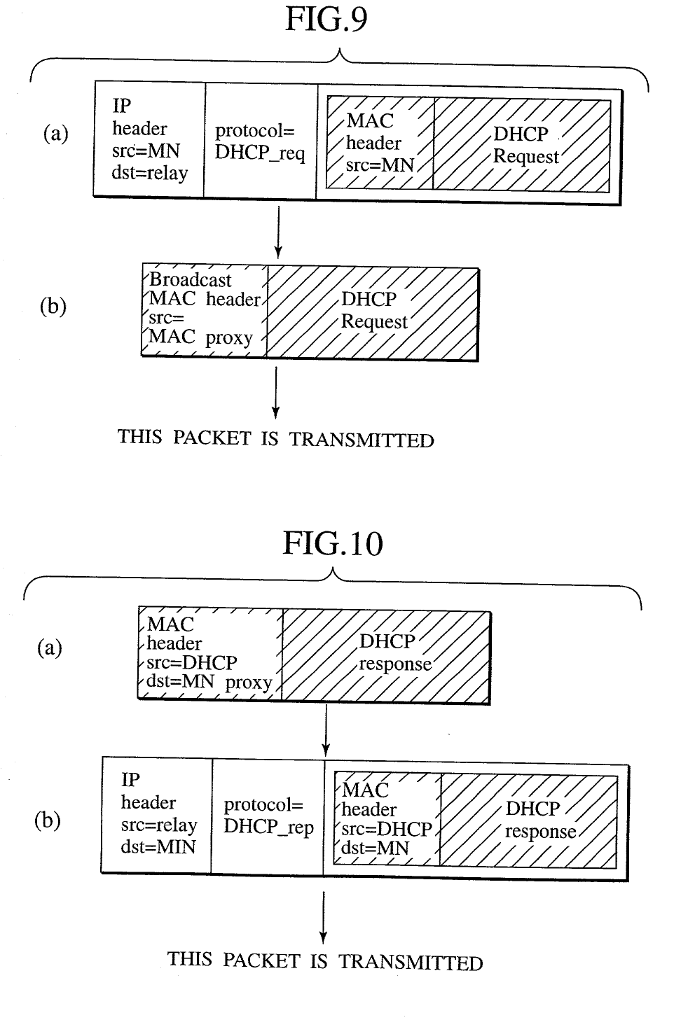

In the case of adopting the method (i), the packet relay device 12 will carry out the packet processing as shown in FIG. 9.

First, the requested protocol of the received packet is recognized (a part (a) of FIG. 9), and the received packet is decapsulated. At this point, it is recognized that this is the DHCP request, so that the link broadcast packet in the payload is taken out next, the MAC source address is replaced by the local link address (MAC-proxy) of the packet relay device 12 (a part (b) of FIG. 9), and this packet is transmitted to the first local subnet 1 and a response from the DHCP server 16 is awaited (step S4). Upon receiving this packet, the DHCP server 16 issues the IP address and returns the DHCP response message containing this IP address (a part (a) of FIG. 10) to the packet relay device 12, and the packet relay device 12 receives this DHCP response message (step S5 of FIG. 5).

Note that the above description is directed to an exemplary case of the DHCP, but any other protocol processing requested from the radio terminal 11 will be handled similarly.

Now, when the packet relay device 12 carries out the prescribed protocol processing on behalf of the request source radio terminal 11 as described above and some protocol response is acquired by the packet relay device 12, there is a need to transmit this protocol response to the radio terminal 11.

In the case of the DHCP, the acquired IP address information is transmitted to the radio terminal 11 through the second radio base station 102. Also, in conjunction with this, an ARP (Address Resolution Protocol) request is issued on the first local subnet 1 in order to relate the MAC address of the first radio interface 111 side of the radio terminal 11 with the acquired IP address.

The IP address information can be transmitted by encapsulating it in an IP packet again and transferring this packet through the second radio base station 102 to the radio terminal 11 (step S6) of FIG. 5).

In this case, the packet relay device 12 will carry out the packet processing as shown in FIG. 10.

First, the packet relay device 12 sets the destination MAC address of the acquired DHCP response message (a part (a) of FIG. 10) to be the same as the source MAC address of the DHCP request that has transferred by the encapsulated packet originally. Then, this message is encapsulated into a packet (having the packet relay device 12 as a source, the radio terminal 11 as a destination, and the DHCP response as the protocol field in the IP header) (a part (b) of FIG. 10), and this packet is transmitted.

This encapsulated DHCP response message is received by the second radio interface 112 of the radio terminal 11 through the backbone network 6, the second local subnet 2, and the second radio base station 102. The radio terminal 11 decapsulates the received packet, and interprets the DHCP response message to acquire the response code, the IP address allocated to the radio terminal 11 at the first local subnet 1, etc. Then, the second radio interface 112 is set as a transmission interface while the first radio interface 111 is set as a reception interface, with respect to this IP address.

Note here that the radio terminal 11 carries out communications across a plurality of spot high speed radio downloading areas, so that when the spatial arrangement of the downloading first radio base stations 101 is known, for example, it becomes possible to realize a control in which the DHCP request is transmitted in advance by the tunneling to the subnets supporting these first radio base stations 101 in order to have the DHCP addresses allocated in advance, such that the communications using the allocated DHCP address can be started immediately when the radio terminal 11 enters one high speed radio downloading area.

The radio terminal 11 shown in FIG. 3 has the DHCP address table 1133 to be used for realizing such a control, where a plurality of DHCP addresses allocated in advance and the radio base stations at which they are active are stored, such that communications can be started by setting an appropriate DHCP address into an IP module as soon as the association with some first radio base station 101 is established through the first radio interface 111.

Of course, the radio terminal 11 appropriately processes the received response message similarly even in the case of the protocol processing other than the DHCP.

Note that the encapsulation function and the decapsulation function described above can be implemented integrally on the radio terminal 11 and the resulting packets can be given to the communication protocol processing unit 113 such that communication control can be realized while maintaining (communication software of) the conventional TCP/IP specification without any change.

Now, when the IP address (which is assumed to be “A”) is acquired at the first radio base station 101 side (as an IP node in the first local subnet 1) as described above, a route via the first radio base station 101 is set as a route in the system for a packet with the destination IP address “A” so that the radio terminal 11 receives the packet with the destination IP address “A” via the first radio base station 101.

On the other hand, a packet corresponding to it, i.e., a packet with the source IP address “A”, is outputted from the second radio interface 112 (because the uplink is not available on the first radio base station 101 side).

In this case, the source IP address “A” of this packet is different from an IP address (which is assumed to be “D”) allocated to the radio terminal 11 by the PPP negotiation with the access server 22 on the second local subnet 2, so that there can be cases where the packet with source IP address (on the first local subnet 1 side) set to be “A” (rather than “D” that the radio terminal 11 should ordinarily use on the second local subnet 2 side) will not be transferred outside the second local subnet 2 by the function provided in the second local subnet 2 as in the case where the check of the source IP address by the packet filter is carried out in the second local subnet 2 for example. Here, it is assumed that there is no such a packet filtering, or it is assumed that transfer of packets from a user registered in advance to outside of the second local subnet 2 is permitted even if there is such a packet filtering.

Consequently, in the radio terminal 11, the routing information is changed such that the second radio interface 112 side will be selected as a default route on the routing table even for a packet with the source IP address set to be the “IP address “A” on the first local subnet 1. In the case of the DHCP, such an additional routing table updating becomes necessary.

At this stage, the radio terminal 11 can carry out communications in the downlink direction (a direction for receiving at the radio terminal 11) via the first local subnet 1 (the first radio base station 101) and communications in the uplink direction (a direction for transmitting from the radio terminal 11) via the second local subnet 2 (the second radio base station 102), with arbitrary device that is connected to the backbone network 6 IP-wise.

An exemplary case of communications with the WWW server 62 is shown in a part (b) of FIG. 6.

The radio terminal 11 transmits a request message with respect to the WWW server 62 from the second radio interface 112, and this request message is received by the WWW server 62 through the second radio base station 102, the second local subnet 2, and the backbone network 6 (step S21). The WWW server 62 processes this request message, and transmits a response message corresponding to this request message. This response message is received by the first radio interface 111 of the radio terminal 11 through the backbone network 6, the first local subnet 1 and the first radio base station 101 (step S22). The radio terminal 11 processes the received response message.

In the above, the exemplary case of the DHCP has been mainly described, but in the case of a protocol that returns only information on or above the transport layer rather than a response that contains the MAC layer as in the DHCP response, the packet relay device 12 may simply transfer the response message packet by rewriting the destination IP address of the response message packet obtained by the proxy processing into the IP address allocated to the second radio interface 112 side of the radio terminal 11.

Also, in the case of the DHCP, the radio terminal 11 transfers the link broadcast with respect to the first local subnet 1 by encapsulating it in a packet destined to the packet relay device 12, but in general, it is also possible to encapsulate a protocol request using the ordinary unicast or multicast and transfer it via the second radio base station 102.

For example, in the case of searching for a node that provides a specific service using the SLP (Service Location Protocol) on the first local subnet 1 side, the radio terminal 11 encapsulates a broadcast or multicast packet into an IP packet and transfers it to the packet relay device 12. In this case, the response message is a message that can be transferred on the ordinary transport layer, so that it suffices for the packet relay device 12 to transfer the response message packet by rewriting the destination IP address of the response message packet into the IP address allocated to the second radio interface 112 side of the radio terminal 11.

Besides that, even in the case of transferring a router solicitation message to be transferred by multicast in order to discover a specific router device on the first local subnet 1 side from the second radio interface 112 side, for example, this can be done via the packet relay device 12 similarly. Also, in the Mobile IP, there is a message called agent solicitation to be transferred by multicast in order to discover an agent that supports a mobile node at the visited site network, and this message is defined as an extension of the router solicitation message so that the mechanism of this embodiment can be utilized directly for this message.

In addition, the present invention is also applicable to the processing other than the transmission of the broadcast or multicast message to a network on the first radio base station 101 side.

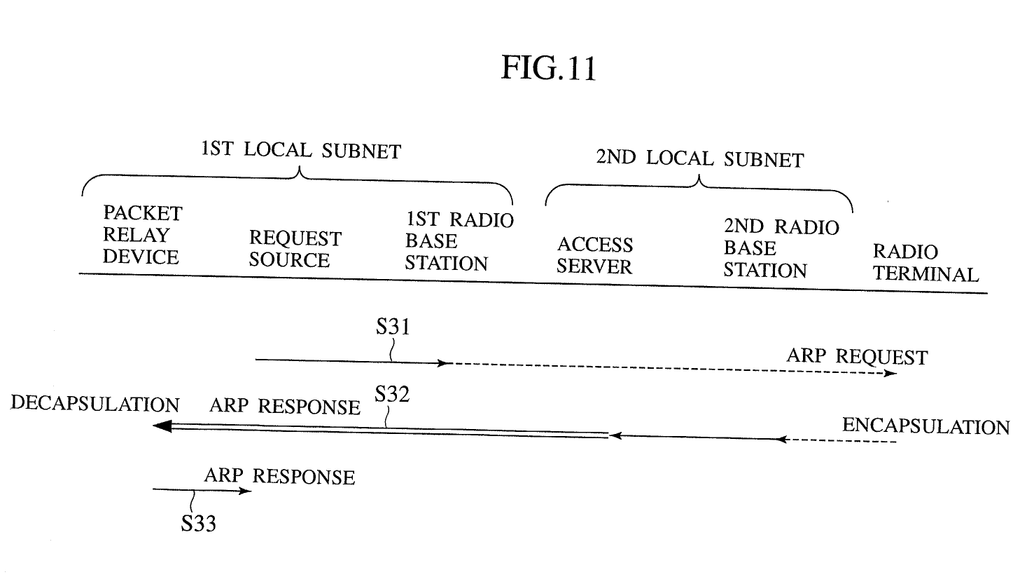

As an example, FIG. 11 shown an exemplary procedure in the case of the ARP.

Here, an ARP request with respect to the mobile node is made on the first local subnet 1 side in general (step S31). At this point, there can be cases where the radio terminal 11 should make an ARP response corresponding to this ARP request. However, the first radio base station 101 is dedicated for the downlink, so that this ARP response message cannot be transferred by using the uplink directly. In this case, it is possible to transfer this ARP response message around the second radio interface 112 side by encapsulating it into a packet destined to the packet relay device 12 (step S32). In this case, the packet relay device 12 decapsulates this packet, and transfers the ARP response message to the ARP request source (step S33).

There is also a case of returning an IGMP (Internet Group Management Protocol) report message in response to an IGMP inquiry message from a multicast router provided on the first local subnet 1 side. Even in this case, the first radio base station 101 is dedicated for the downlink so that this IGMP report message cannot be transferred by using the uplink directly. In this case, again, it is possible to transfer this IGMP report message around the second radio interface 112 side by encapsulating it into a packet destined to the packet relay device 12. In this case, the packet relay device 12 decapsulates this packet and transmits the IGMP report message to the multicast router.

As described above, there are many variations regarding a layer at which a protocol operates (application layer, network layer (IP layer), datalink layer, etc.), and a range of correspondents of the radio terminal (unicast, multicast, broadcast), but by utilizing the present invention, it is possible to utilize (communication software of) protocols used in the conventional TCP/IP without requiring any change, even when there is a limitation that only transfer in the downlink direction is available from the first local subnet on the first radio base station side to the radio terminal, by transferring a message destined to the first local subnet on the first radio base station side around the second radio interface 112 side (the second local subnet side) using the encapsulation transfer with respect to the packet relay device according to the present invention.

Now, in the case where the departure of the radio terminal 11 from the radio areas of all the first radio base stations 101 is detected as the radio terminal 11 moves, the setting is to be changed to carry out communications in both directions via the second radio base station 102.

Here, the method for detecting the departure from the radio areas of the first radio base stations 101 is not limited to any specific method, but can be a method in which the first radio base stations 101 are transmitting the beacon messages regularly and a state of departure from the radio areas of the first radio base stations 101 is recognized when it becomes impossible to receive this beacon message, or a method in which the foreign agent 16 exists and a state of departure from the radio areas of the first radio base stations 101 is recognized when it becomes impossible to receive the agent advertisement message that is regularly transmitted by the foreign agent 16 for a prescribed period of time.

Note that the above description is directed to the case of utilizing the first radio base station 101 for the communications in the downlink direction at higher priority when the radio terminal 11 has moved into the radio area of the first radio base station 101 from outside the radio area, but it is also possible to use a configuration in which a user can select the radio base station to be utilized for the communications in the downlink direction as the first radio base station 101 or the second radio base station 102.

In this case, the processing for utilizing the first radio base station 101 for the communications in the downlink direction is carried out only when the radio terminal 11 exists in the radio area of the first radio base station 101 and the use of the first radio base station 101 for the communications in the downlink direction is selected.

For example, this can be the case when the radio terminal 11 moves into the radio area of the first radio base station 101 from outside the radio area in a state where the use of the first radio base station 101 for the communications in the downlink direction is already selected, or when the use of the first radio base station 101 for the communications in the downlink direction is selected in a state where the radio terminal 11 is already in the radio area of the first radio base station 101.

Similarly, the above description is directed to the case of utilizing the second radio base station 102 for the communications in the downlink direction when the radio terminal 11 has moved out from inside the radio area of the first radio base station 101, but it is also possible to use a configuration in which a user can select the radio base station to be utilized for the communications in the downlink direction as the first radio base station 101 or the second radio base station 102.

In this case, the processing for utilizing the second radio base station 102 for the communications in the downlink direction is carried out only when the radio terminal 11 does not exist in the radio area of the first radio base station 101 or the use of the first radio base station 101 for the communications in the downlink direction is not selected.

For example, this can be the case when the radio terminal 11 moves out from inside the radio area of the first radio base station 101 or when the use of the second radio base station 102 for the communications in the downlink direction is selected in a state where the radio terminal 11 is already in the radio area of the first radio base station 101. Also, this selection may be made for each application, or according to the amount of communication data, for example.

As described, according to the present invention, the packet relay device for processing a request message of a prescribed protocol on behalf of the radio terminal is provided at a first sub-network which is capable of communications in the downlink direction with respect to the radio terminal only. Then, a request message encapsulated in an IP packet is transferred from the radio terminal to the packet relay device via the second sub-network which is capable of communications in both uplink direction and the downlink direction with respect to the radio terminal, and a response message corresponding to the request message is transferred from the packet relay device to the radio terminal, so that it becomes possible for the radio terminal to execute a prescribed protocol with respect to the first sub-network.

It is to be noted that the above embodiment has been described for the case where the first radio base station 101 is capable of transmission only and the first radio interface 111 of the radio terminal 11 is capable of reception only, but the present invention is also applicable to the other cases where the radio terminal 11 cannot transmit messages to the first radio base station 101 by using the first radio interface 111.

For example, this can be the case when the first radio base station 101 is capable of both transmission and reception but the first radio interface 111 of the radio terminal 11 is capable of reception only (in which case other terminals having bidirectional radio communication function with respect to the first radio base station 101 may coexist), or when the first radio interface 111 of the radio terminal 11 is capable of both transmission and reception but the first radio base station 101 is capable of transmission only.

It is also to be noted that the above embodiment has been described for the case of using a radio network as a bidirectional wide-area network, but the present invention is also applicable to the case of using a wire network (such as a public telephone network or a data communication network, for example) as a bidirectional wide-area network.

It is also to be noted that the above described embodiments according to the present invention may be conveniently implemented using a conventional general purpose digital computer programmed according to the teachings of the present specification, as will be apparent to those skilled in the computer art. Appropriate software coding can readily be prepared by skilled programmers based on the teachings of the present disclosure, as will be apparent to those skilled in the software art.

In particular, each of the radio terminal and the packet relay device of the above described embodiment can be conveniently implemented in a form of a software package.

Such a software package can be a computer program product which employs a storage medium including stored computer code which is used to program a computer to perform the disclosed function and process of the present invention. The storage medium may include, but is not limited to, any type of conventional floppy disks, optical disks, CD-ROMs, magneto-optical disks, ROMs, RAMs, EPROMs, EEPROMs, magnetic or optical cards, or any other suitable media for storing electronic instructions.

It is also to be noted that, besides those already mentioned above, many modifications and variations of the above embodiment may be made without departing from the novel and advantageous features of the present invention. Accordingly, all such modifications and variations are intended to be included within the scope of the appended claims.

What is claimed is:

1. A network system, comprising:
a radio terminal having a first communication interface usable for reception only and a second communication interface usable for transmission and reception;
a first sub-network to which the radio terminal can be connected through a radio base station of a downlink radio network by using the first communication interface;
a second sub-network to which the radio terminal can be connected through a bidirectional communication network by using the second communication interface, the second sub-network being connected with the first sub-network through a backbone network; and
a packet relay device configured to receive a request message requesting a protocol processing with respect to the first sub-network from the radio terminal through the second sub-network, and carry out the protocol processing on the first sub-network according to the request message on behalf of the radio terminal, such that a response message corresponding to the request message obtaining by the protocol processing is returned from the first sub-network to the radio terminal through the downlink radio network or the bidirectional communication network.

2. The network system of claim 1, wherein the radio terminal is configured to receive a notification message indicating an existence or an address of the packet relay device on the first sub-network through the downlink radio network by using the first communication interface when the radio terminal enters a radio area of the radio base station, and transmit the request message after receiving the notification message at the first communication interface, by encapsulating the request message into an IP (Internet Protocol) packet destined to the address of the packet relay device obtained according to the notification message and transmitting the IP packet from the second communication interface;
the packet relay device is configured to decapsulate the IP packet received from the radio terminal through the second sub-network, carry out the protocol processing on behalf of the radio terminal according to the request message taken out from the IP packet, and transmit the response message in a form of a prescribed packet that can be received by the second communication interface of the radio terminal through the second sub-network; and
the radio terminal is also configured to process the response message contained in the prescribed packet received by the second communication interface.

3. A packet relay device for use in a network system containing a radio terminal having a first communication interface usable for reception only and a second communication interface usable for transmission and reception, a first sub-network to which the radio terminal can be connected through a radio base station of a downlink radio network by using the first communication interface, and a second sub-network to which the radio terminal can be connected through a bidirectional communication network by using the second communication interface, the second sub-network being connected with the first sub-network through a backbone network, the packet relay device comprising:
a communication interface configured to receive an encapsulated IP packet containing a request message requesting a protocol processing with respect to the first sub-network, which is transferred from the radio terminal located in a radio area of the radio base station through the second sub-network;
a processing unit configured to decapsulate the encapsulated IP packet received by the communication interface so as to take out the request message, and carry out the protocol processing on the first sub-network according to the request message on behalf of the radio terminal.

4. The packet relay device of claim 3, wherein the communication interface is also configured to transmit a response message corresponding to the request message obtained by the protocol processing in a form that can be received by the radio terminal through the second sub-network.

5. The packet relay device of claim 4, wherein the communication interface is configured to transmit the response message by rewriting a destination address of the response message into an IP (Internet Protocol) address acquired by the radio terminal at a second sub-network side.

6. The packet relay device of claim 4, wherein the communication interface is configured to transmit the response message by encapsulating the response message into an IP (Internet Protocol) packet destined to an IP address acquired by the radio terminal at a second sub-network side.

7. The packet relay device of claim 3, wherein when the request message is a DHCP (Dynamic Host Configuration Protocol) request message, the processing unit transmits the DHCP request message to the first sub-network and receives a DHCP response message from a DHCP server that processed the DHCP request message.

8. A radio terminal for use in a network system containing a first sub-network to which the radio terminal can be connected through a radio base station of a downlink radio network, a second sub-network to which the radio terminal can be connected through a bidirectional communication network, the second sub-network being connected with the first sub-network through a backbone network, and a packet relay device for carrying out a protocol processing on the first sub-network on behalf of the radio terminal, the radio terminal comprising:
a first communication interface usable for reception only, by which the radio terminal can be connected to the first sub-network, which is configured to receive a notification message indicating an existence or an address of the packet relay device on the first sub-network through the downlink radio network when the radio terminal enters a radio area of the radio base station;
a second communication interface usable for transmission and reception, by which the radio terminal can be connected to the second sub-network, which is configured to transmit a request message requesting a protocol processing with respect to the first sub-network after receiving the notification message at the first communication interface, by encapsulating the request message into an IP (Internet Protocol) packet destined to the address of the packet relay device obtained according to the notification message and transmitting the IP packet through the second sub-network; and
a processing unit configured to process a response message corresponding to the request message obtained by the protocol processing.

9. The radio terminal of claim 8, wherein the second communication interface is also configured to receive the response message transmitted from the packet relay device through the second sub-network.

10. The radio terminal of claim 8, wherein when the response message is an encapsulated IP packet, the second communication interface decapsulates the encapsulated IP packet so as to take out the response message and gives the response message taken out from the encapsulated IP packet to the processing unit.

11. The radio terminal of claim 8, wherein the notification message is provided in a form of a specific message to be regularly transmitted by the radio base station or a specific node provided in the first sub-network, and the first communication interface is configured to acquire information indicating the existence or the address of the packet relay device by receiving the specific message regularly transmitted by the radio base station or the specific node.

12. The radio terminal of claim 8, wherein the second communication interface transmits the request message in a form of a broadcast packet with respect to the first sub-network or a multicast packet with respect to a prescribed group of nodes on the first sub-network.

13. The radio terminal of claim 8, wherein the second communication interface transmits the request message which is any one of a DHCP (Dynamic Host Configuration Protocol) request message with respect to the first sub-network, a router solicitation message with respect to the first sub-network, an IGMP (Internet Group Management Protocol) report message with respect to a multicast router on the first sub-network, an ARP (Address Resolution Protocol) response message with respect to the first sub-network, and an SLP (Service Location Protocol) request message with respect to the first sub-network.

14. The radio terminal of claim 13, wherein when the request message If the DHCP request message, upon receiving a DHCP response message corresponding to the DHCP request message, the processing unit sets the second communication interface as a transmission interface and the first communication interface as a reception interface with respect to an IP (Internet Protocol) address allocated to the radio terminal on the first sub-network that is contained in the DHCP response message.

15. A packet processing method in a network system containing a radio tarrying out the protocol processing o network according to the request message on behalf of the radio terminal at the packet relay device; and
returning a response message corresponding to the request message obtained by the protocol processing from the first sub-network to the radio terminal through the downlink radio network or the bidirectional communication network.

16. The method of claim 15, further comprising:
receiving at the radio terminal a notification message indicating an existence or an address of the packet relay device on the first sub-network through the downlink radio network by using the first communication interface when the radio terminal enters a radio area of the radio base station:
transmitting from the radio terminal the request message after receiving the notification message at the first communication interface, by encapsulating the request message into an IP (Internet Protocol) packet destined to the address of the packet relay device obtained according to the notification message and transmitting the IP packet from the second communication interface;
decapsulatlng the IP packer received from the radio terminal through the second sub-network at the packet relay device, such that the protocol processing is carried out on behalf of the radio terminal according to the request message taken out from the IF packet at the packet relay device;
transmitting the response message in a form of a prescribed packet that can be received by the second communication interface of the radio terminal through the second sub-network From the packet relay device; and
processing the response message contained in the prescribed packet received by the second communication interface at the radio terminal.

17. A packet processing method at a packet relay device in a network system containing a radio terminal having a first communication Interface usable for reception only and a second communication interface usable for transmission and reception, a first sub-network to which the radio terminal can be connected through a radio base station of a downlink radio network by using the first communication interface, a second sub-network to which the radio terminal can be connected through a bidirectional communication network by using the second communication Interface, and the second sub-network being connected with the first sub-network through a backbone network, the method comprising:
receiving an encapsulated IP packet containing a request message requesting a protocol processing with respect to the first sub-network, which is transferred from the radio terminal located in a radio area of the radio base station through the second sub-network; and
decapsulatlng the encapsulated IP packet received by the receiving step so as to take out the request message, and carrying out the protocol processing on the first sub-network according to the request message on behalf of the radio terminal.

18. A packet processing method at a radio terminal in a network system containing a first sub-network to which the radio terminal can be connected through a radio base station of a downlink radio network, a second sub-network to which the radio terminal can be connected through a bidirectional communication network, the second sub-network being connected with the first sub-network through a backbone network, and a packet relay device for carrying out a protocol processing on the first sub-network on behalf of the radio terminal, the method comprising:
receiving a notification message indicating an existence or an address of the packet relay device on the first sub-network through the downlink radio network when the radio terminal enters a radio area of the radio base station, using a first communication interface usable for reception only, by which the radio terminal can be connected to the first sub-network;
transmitting a request message requesting a protocol processing with respect to the first sub-network after receiving the notification message at the first communication interface, by encapsulating the request message into an IP (Internet Protocol) packet destined to the address of the packet relay device obtained according to the notification message and transmitting the IP packet through the second sub-network, using a second communication interface usable for transmission and reception, by which the radio terminal can be connected to the second sub-network; and
processing a response message corresponding to the request message obtained by the protocol processing.

19. A computer usable medium having computer readable program codes embodied therein for causing a computer to function as a packet relay device in a network system containing a radio terminal having a first communication interface usable for reception only and a second communication interface usable for transmission and reception, a first sub-network to which the radio terminal can be connected through a radio base station of a downlink radio network by using the first communication interface, and a second sub-network to which the radio terminal can be connected through a bidirectional communication network by using the second communication interface, the second sub-network being connected with the first sub-network through a backbone network, the computer readable program codes include:
a first computer readable program code for causing said computer to receive an encapsulated IP packet containing a request message requesting a protocol processing with respect to the first sub-network, which is transferred from the radio terminal located In a radio area of the radio base station through the second sub-network; and
a second computer readable program code for causing said computer to decapsulate the encapsulated IP packet received by the first computer readable program code so as to take out the request message, and carry out the protocol processing on the first sub-network according to the request message on behalf of the radio terminal.

20. A computer usable medium having computer readable program codes embodied therein for causing a computer to function as a radio terminal in a network system containing a first sub-network to which the radio terminal can be connected through a radio base station of a downlink radio network, a second sub-network to which the radio terminal can be connected through a bidirectional communication network, the second sub-network being connected with the first sub-network through a backbone network, and a packet relay device for carrying out a protocol processing on the first sub-network on behalf of the radio terminal, the computer readable program codes include:
a first computer readable program code for causing said computer to receive a notification message indicating an existence or an address of the packet relay device on the first sub-network through the downlink radio network when the radio terminal enters a radio area of the radio base station, using a first communication interface usable for reception only, by which the radio terminal can be connected to the first sub-network;
a second computer readable program code for causing said computer to transmit a request message requesting a protocol processing with respect to the first sub-network after receiving the notification message at the first communication interface, by encapsulating the request message into an IP (Internet Protocol) packet destined to the address of the packet relay device obtained according to the notification message and transmitting the IP packet through the second sub-network, using a second communication interface usable for transmission and reception, by which the radio terminal can be connected to the second sub-network; and
a third computer readable program code for causing said computer to process a response message corresponding to the request message obtained by the protocol processing.
